(19) United States
(12) Patent Application Publication
(10) Pub. No.: US 2026/0054170 A1
(43) Pub. Date: Feb. 26, 2026

(54) TRAINING SYSTEMS FOR FULLY CONTROLLED CAMERAS IN INTERACTIVE GAMES

(71) Applicant: Skydance SIlicon Valley, LLC, Santa Monica, CA (US)

(72) Inventors: Jeremy Luke Isaak, Canada (CA); Julian Anthony Beak, Santa Monica, CA (US)

(73) Assignee: Skydance Silicon Valley, LLC, Santa Monica, CA (US)

(21) Appl. No.: 19/301,415

(22) Filed: Aug. 15, 2025

Related U.S. Application Data
(60) Provisional application No. 63/686,384, filed on Aug. 23, 2024.

(51) Int. Cl. A63F 13/5252; A63F 13/5258

(52) U.S. Cl. CPC A63F 13/5252; A63F 13/5258

(57) ABSTRACT

Embodiments described herein include systems and methods for a fully controlled camera system within interactive environments, including video games. The process involves initializing a camera setup across a plurality of interactive environments, such as game levels or scenes. For each environment, at least one camera point is established, and one or more camera characteristics are added to define the camera's behavior and visual style. In some embodiments, this is performed manually by a developer. In additional embodiments, a machine learning assisted approach is utilized, where input data such as telemetry data and restriction parameters are processed by machine learning models. These models can automatically generate an initial configuration, suggesting optimal locations for camera points and their associated characteristics. This initial configuration can then be received and further refined through manual adjustments. Upon determining that all environments have been configured, an interactive experience with a seamless, cinematic camera system is deployed.

### PRIORITY

This application claims the benefit of, and priority to U.S. Provisional Application, entitled “Training Systems for Fully Controlled Cameras in Interactive Games,” filed on Aug. 23, 2024 and having application Ser. No. 63/686,384, the entirety of each of said application being incorporated herein by reference.

### FIELD

The present disclosure relates to interactive games. More particularly, the present disclosure relates to setting up a fully controlled camera system within an interactive game.

### BACKGROUND

In three-dimensional interactive games, the use of camera controls has been highly prevalent, as it allows players to navigate and interact with complex environments. Players typically use control sticks or mouse inputs to adjust the camera angle, ensuring they have a view of their surroundings and can respond to in-game challenges. However, in these traditional games where players control the game camera with, for example, a control stick, a common issue is that players spend significant amounts of time staring at the back of their main character. This setup often results in a detached experience, where the player feels like they are controlling a remote-controlled object rather than embodying the character they are playing. The constant rear view limits the sense of immersion, making it difficult for players to fully engage with the game world and the character's experiences.

Controlling a three-dimensional game camera can also present a steep learning curve, particularly for newer players who may struggle with the complexity of navigating and adjusting the camera. Unlike two-dimensional games where movement and perspective are straightforward, three-dimensional environments require players to manage an additional axis of control, often leading to disorientation and frustration. New players must learn to coordinate their character's movements with the camera's angle, ensuring they maintain a clear view of their surroundings while also responding to in-game challenges. This dual tasking can sometimes be overwhelming, as it involves mastering the use of control sticks or mouse inputs to achieve smooth and precise camera adjustments. Additionally, the sensitivity settings, inversion options, and various camera modes can add layers of complexity, making it difficult for inexperienced players to find a comfortable setup.

These challenges can detract from the enjoyment of the game, as players may spend more time wrestling with camera controls than engaging with the gameplay and story, potentially discouraging continued play and diminishing the overall gaming experience. These issues can create a psychological barrier for the player, reducing the emotional connection and sense of presence within the game. Instead of feeling like they are part of the action, players may feel more like observers, which can diminish the overall impact of storytelling and character development.

### SUMMARY OF THE DISCLOSURE

Systems and methods for deriving one or more filter rules to filter unwanted broadcast packets and/or messages at access point level in accordance with embodiments of the disclosure are described herein.

In some embodiments, a device includes a processor, a memory communicatively coupled to the processor, and a full control camera logic, stored in the memory and executed by the processor, configured to initialize a camera setup process within a plurality of interactive environments, select one of the plurality of interactive environments, set up at least one camera points within the selected one interactive environment, add one or more camera characteristics to the at least one camera point, determine if all of the plurality of interactive environments have been selected, and deploy, upon determining that all of the plurality of interactive environments were selected, an interactive experience.

In some embodiments, the interactive experience is a video game environment.

In some embodiments, the interactive environments are unique portions of the video game environment.

In some embodiments, deploying the video game environment includes at least rendering a portion of at least one interactive environment.

In some embodiments, the rendering occurs in real-time or near real-time.

In some embodiments, the selected one of the plurality of interactive environments has telemetry data associated with it.

In some embodiments, the full control camera logic is further configured to receive one or more restriction parameters.

In some embodiments, the full control camera logic is further configured to format the camera characteristics and restriction parameters into a machine-learning compatible input.

In some embodiments, the full control camera logic is further configured to transmit machine-learning compatible input.

In some embodiments, a device, wherein the full control camera logic is further configured to receive an automatically generated initial configuration.

In some embodiments, a device, wherein the full control camera logic is further configured to receive one or more manual adjustments to the automatically generated initial configuration.

In some embodiments, a device, including a processor, a memory communicatively coupled to the processor, and a full control camera logic, stored in the memory and executed by the processor, configured to select one of the plurality of interactive environments, retrieve available input data, process the input data through a first plurality of machine learning models, receive a first output data associated with locations of one or more camera points within the selected interactive environment, process the first output data through a second plurality of machine learning models, and receive a second output data associated with one or more camera characteristics of the one or more camera points of the first output data.

In some embodiments, a device, wherein the interactive experience is a video game environment.

In some embodiments, a device, wherein the interactive environments are unique portions of the video game environment.

In some embodiments, a device, wherein deploying the video game environment includes at least rendering a portion of at least one interactive environment.

In some embodiments, a device, wherein the rendering occurs in real-time or near real-time.

In some embodiments, a device, wherein the wherein the available input data includes at least telemetry data.

In some embodiments, a device, wherein the available input data includes at least one or more restriction parameters.

In some embodiments, a method of automatically generating camera configurations within interactive environments, including initializing a camera setup process within a plurality of the interactive environments, selecting one of the plurality of the interactive environments, setting up at least one camera points within the selected interactive environment, adding one or more camera characteristics to the at least one camera point, determining if all of the plurality of interactive environments have been selected, and generating automatically, upon determining that all of the plurality of interactive environments were selected, an initial configuration.

In some embodiments, a device, wherein the method further includes receiving one or more manual adjustments to the automatically generated initial configuration.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a video game ecosystem in accordance with various embodiments of the disclosure;

FIG. 2 is a conceptual block diagram of a device suitable for configuration with a full control camera logic, in accordance with various embodiments of the disclosure;

FIG. 3 is an abstract block diagram of the components of a fully controlled camera system 300 in accordance with various embodiments of the disclosure;

FIG. 4 is an abstract block diagram of the data within a storage of a fully controlled camera system in accordance with various embodiments of the disclosure;

FIG. 5 is a conceptual illustration of manual camera point setup in accordance with various embodiments of the disclosure;

FIG. 6 is a conceptual illustration of machine-learning assisted camera point setup in accordance with various embodiments of the disclosure;

FIG. 7 is a flowchart depicting a process for setting up camera points in a game environment in accordance with various embodiments of the disclosure;

FIG. 8 is a flowchart depicting a process for a machine-learning assisted camera point setup in accordance with various embodiments of the disclosure; and

FIG. 9 is a flowchart depicting a process for automatically generating camera point suggestions in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems outlined above, embodiments of the disclosure described herein can utilize an innovative fully controlled camera system in a game where the camera automatically switches between different angles during gameplay, unlike traditional games where players manually control the camera. This system can leverage various cinematographic principles to make these cuts occur and are perceived seamlessly, enhancing the cinematic quality of the game and maintaining immersion. In many embodiments, a goal is to create a gameplay experience that looks and feels like a movie, with dynamic camera angles and transitions that respond to the action in real-time.

In traditional games a single orbiting camera is often used that players can control, but embodiments described herein can integrate various heuristics and other processes to manage camera angles automatically, adhering to rules of cinema such as the 180-degree rule, avoiding jump cuts, and framing shots effectively. This approach can allow the game to maintain a cinematic feel even during intense combat scenes, making the gameplay look like a polished action movie.

The fully controlled camera system can be configured to keep players oriented and engaged by using screen-relative controls, meaning the direction the player moves is always consistent with what they see on screen, regardless of camera angle changes. This can reduce the learning curve and disorientation for players, allowing them to focus on the action rather than camera management. In many embodiments, an aim is to perfect the fully controlled camera system to the point where manual camera control is unnecessary, providing a seamless and intuitive experience that aligns with narrative and gameplay needs.

Various embodiments described herein can facilitate these automatic camera cuts by scoring a plurality of cameras associated with various camera points in different gaming environments. For example, as the player moves throughout the game world, they encounter different environments, levels, or other areas. Each of these locations can be configured with various camera points that may be static in the scene or dynamically located such as over-the-shoulder shots. Each camera that may be selected to cut to in a game scene can have a score associated with it. These scores can be utilized to compare and select which camera should be next when a cut point event is encountered. As described in more detail below, each camera point can have a variety of data associated with it that can color the way the score is weighted and/or otherwise evaluated. As camera scores cross a given threshold, the fully controlled camera system can initiate a cut to that camera within the scene.

In many embodiments, adding camera points and their associated characteristics manually in a game environment can be a highly tedious process without some level of automation. This meticulous task requires the developer to place each camera point individually within the game world, ensuring it captures the desired view and context for various gameplay scenarios. Each camera point needs to be positioned precisely, often requiring numerous adjustments to account for factors like player movement, environmental obstacles, and optimal angles.

For each camera point, the developer may also configure a wide range of parameters, including the field of view, depth of field, focal length, and orientation. These settings are often fine-tuned to ensure the camera captures the action effectively and provides a visually appealing perspective. Additionally, the developer(s) can assign contextual behaviors, such as when and how the camera activates, which may involve setting up triggers based on player actions or specific events in the game.

The process of adding in camera points manually may become even more labor-intensive when considering the need for consistent testing and iteration. After placing and configuring a camera point, the developer may test it in the actual gameplay environment to ensure it functions as intended. This can involve playing through scenarios, observing the camera's behavior, and making necessary adjustments. If the camera point does not perform optimally, the developer can then return to the editor, modify the settings, and test again. This cycle may repeat multiple times for each camera point, significantly extending the development timeline.

Without automation, this manual approach not only consumes a considerable amount of time but also increases the risk of inconsistencies and human error. Developers might miss optimal placements or fail to adjust parameters correctly, leading to subpar camera performance that can affect the overall player experience. The repetitive nature of the task can also lead to fatigue and oversight, further impacting the quality of the camera system.

Automation, such as using machine learning models or procedural algorithms, can significantly alleviate these challenges. Automated systems can quickly generate initial camera points based on data analysis, ensuring broad coverage and optimal placement. These systems can also pre-configure basic parameters, reducing the amount of manual adjustment needed. By leveraging automation, developers can focus their efforts on fine-tuning and creative adjustments, ensuring the camera system not only performs well technically but also enhances the narrative and aesthetic quality of the game. This approach streamlines the development process, reduces errors, and allows for a more efficient and effective camera system implementation.

In the context of this disclosure, an interactive environment may refer to any discrete, navigable, and self-contained area within a larger interactive experience, such as a video game. These environments can represent distinct levels, scenes, rooms, open world regions, or any specific portion of the game world where player interaction and gameplay occur. Each interactive environment may have its own unique set of assets, such as geometry, textures, lighting, and points of interest, which collectively define its spatial and visual characteristics. The demarcation of interactive environments allows for a structured approach to camera system design, enabling developers to configure unique sets of camera points and behaviors tailored to the specific gameplay requirements and narrative context of that area.

Furthermore, an interactive environment can be characterized by the set of possible player actions and system events that can unfold within its boundaries. This can include specific challenges, puzzles, combat encounters, or narrative sequences. The configuration of a fully controlled camera system within an interactive environment is therefore dependent on analyzing these potential interactions to ensure optimal camera placement and behavior. The system may process data specific to an environment, such as its dimensions, play area data, and telemetry data from previous player sessions within that same environment, to automatically generate or manually refine a camera setup that enhances immersion, visibility, and the overall cinematic quality of the player experience for that particular segment of the game.

A camera point, as described in various embodiments, may represent a specific location and a set of predefined parameters within a three dimensional interactive environment from which a virtual camera can capture a scene. It is not merely a set of spatial coordinates, but rather a comprehensive data structure that defines a potential shot or perspective. A camera point can be static, fixed at a specific location in the environment, or dynamic, configured to follow a character or object according to predefined rules. The setup of at least one camera point within an environment is a foundational step in creating a fully controlled camera system, as these points serve as the available options from which the system can choose to render the gameplay for the player.

Each camera point may be associated with a rich set of camera characteristics that dictate how the scene is viewed from that specific vantage. These characteristics can include orientation, field of view, lens type, depth of field, and movement behaviors. Additionally, a camera point can have contextual information assigned to it, such as triggers for activation or a base score that influences its likelihood of being selected by the virtual editor logic. In an automated setup process, machine learning models can be used to suggest the optimal placement of these camera points by analyzing environmental data and player telemetry, thereby providing a robust framework of potential camera views that a developer can then manually refine to achieve a desired cinematic effect.

Within the scope of the present disclosure, camera characteristics may refer to the collection of configurable parameters and attributes that define the behavior, style, and visual properties of a virtual camera associated with a specific camera point. These characteristics are essential for translating a simple camera location into a nuanced and cinematically effective shot. The characteristics can be broadly categorized into several groups, including lens properties, movement dynamics, framing rules, and simulated operator behaviors. For example, lens characteristics may include focal length, aperture, and focus distance, which control the zoom, depth of field, and clarity of the image.

Adding one or more camera characteristics to a camera point is a critical step in both manual and machine learning assisted setup processes. Movement characteristics may define how a camera behaves, such as whether it is a static tripod shot, a smooth dolly track, a handheld shot with realistic shake, or a drone style aerial view. Framing characteristics can ensure that subjects are composed aesthetically within the shot, adhering to principles like the rule of thirds. In more advanced embodiments, characteristics can even simulate the style of a virtual cameraman, adding subtle imperfections or human like adjustments to enhance realism. The selection and fine tuning of these characteristics allow developers to create a diverse palette of camera shots that the fully controlled camera system can dynamically switch between to craft a compelling and immersive visual narrative for the player.

Telemetry data, in accordance with various embodiments, may encompass the aggregated and often anonymized information collected from actual player gameplay sessions. This data provides empirical insights into how players interact with the game, navigate its environments, and respond to various gameplay scenarios. Telemetry data can include a wide array of metrics, such as player movement paths, character actions, time spent in specific areas, frequency of certain events, and camera positioning in games with manual camera controls. This rich dataset serves as a valuable input for training machine learning models to understand emergent player behavior and identify optimal camera placements that may not be obvious from a purely design centric perspective.

The utilization of telemetry data is particularly advantageous in the context of automatically generating an initial configuration for a fully controlled camera system. By processing historical telemetry data, a machine learning model can identify common points of interest, frequently traversed paths, and areas where players historically struggled with visibility. The model can then suggest camera point locations and characteristics that cater to these observed patterns, for example, by placing cameras that provide clear views of critical objectives or that frame action sequences effectively based on how players typically engage in combat. This data driven approach allows for the creation of a more intuitive and responsive camera system that is refined based on the collective experience of the player base, leading to a more polished and enjoyable interactive experience.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C. ”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

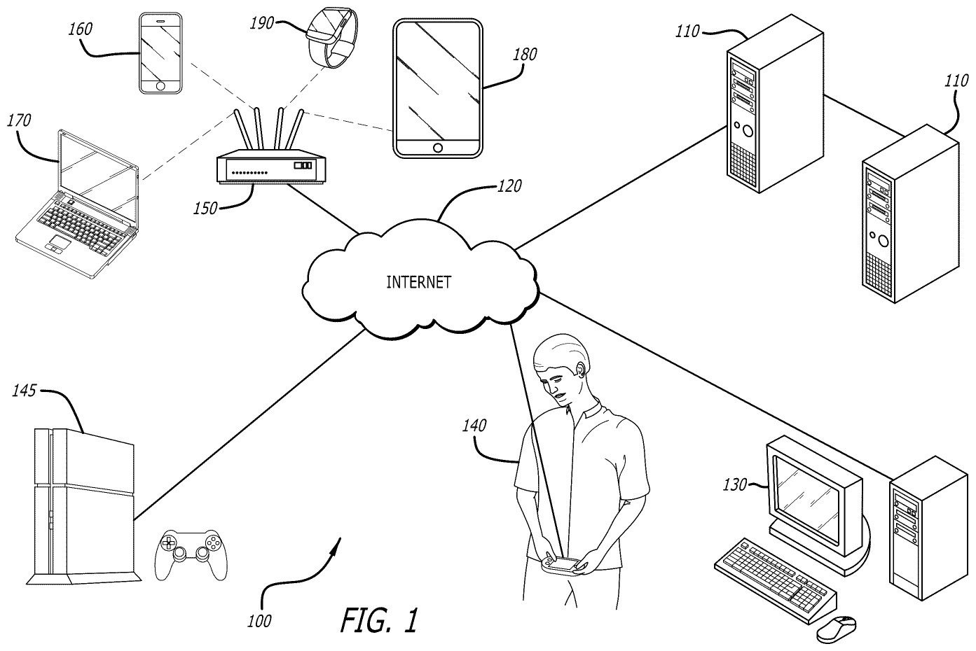

Referring to FIG. 1, a video game ecosystem 100 in accordance with various embodiments of the disclosure is shown. In many embodiments, the game can be designed to seamlessly integrate and function across various devices, including servers 110, home gaming consoles 145, mobile gaming consoles 140, laptops 170, personal computers 130, tablets 180, smartphones 160, wearable devices 190, and more. This integration can ensure a consistent and optimized gaming experience, regardless of the device being used.

In some embodiments, the game can be developed using a modular architecture, enabling compatibility and scalability across multiple platforms. The core game logic, assets, and the camera system may be abstracted into platform-agnostic modules. These modules can be encapsulated in a game engine designed to handle platform-specific requirements dynamically. As those skilled in the art will recognize, certain embodiments, such as games that require a client/server relationship may require one or more aspects of the game to be processed server-side in one or more of the servers 110.

In a number of embodiments, distribution of the game across the various platforms may leverage cloud-based infrastructure, enabling seamless delivery of game content to end-users. Upon release, the game can be hosted on central servers 110 equipped with, or working in conjunction with, content delivery networks (CDNs) to minimize latency and ensure quick access. Players may download the game client tailored to their specific device. For home gaming consoles and personal computers, distribution can be through established digital storefronts, such as the PlayStation Network, Xbox Live, Steam, and others. Mobile and tablet versions may be available via app stores like Google Play and Apple's App Store. Additionally, wearable devices and newer platforms can access the game through dedicated portals or companion apps.

In various embodiments, upon installation, the game may communicate with central servers 110 to authenticate users, sync progress, and manage in-game assets. In some embodiments, for instance, on higher-performance home gaming consoles 145 and PCs 130, the game may provide high-resolution, dynamic range views with advanced effects like depth of field and motion blur. On mobile devices and tablets, the camera system can optimize for performance, ensuring smooth gameplay while maintaining visual fidelity.

Certain embodiments of the ecosystem 100 may allow for cross-platform play, allowing users to interact and play together regardless of the device they are using. This architecture can support this by maintaining a unified player database and real-time synchronization of game states. In various embodiments, the camera system can adjust its parameters, scores, or views based on the device in use or the current state of other players within the online game, ensuring a consistent gameplay experience.

In more embodiments, updates can be distributed through the same channels as the original game, ensuring that all devices receive the latest features, bug fixes, and improvements simultaneously. The fully controlled camera system and any associated logic, being a part of the gameplay experience, may also receive regular updates and telemetry data to enhance functionality and performance based on user feedback and advancements in technology.

In additional embodiments, the ecosystem 100 can include one or more servers 110 that can play a role in ensuring smooth operation, synchronization, and management of the game across various devices. The server 110 can be configured to handle various operations such as, but not limited to, user authentication, ensuring that only legitimate users can access the game. This process may involve verifying login credentials and managing user sessions. Additionally, the server 110 can manage authorization, determining what resources and features each user is permitted to access based on their account type and progress within the game.

In further embodiments, the server 110 can maintain the game's overall state, ensuring consistency and synchronization across all connected devices. This may involve tracking player progress, in-game events, and real-time interactions. For multiplayer scenarios, the server 110 can ensure that all players experience the same game state, coordinating actions and updates to maintain a seamless multiplayer experience.

In still more embodiments, servers 110 can be responsible for delivering game content, including initial game files, updates, patches, and downloadable content (DLC). They may utilize content delivery networks (CDNs) to distribute these files efficiently, reducing latency and ensuring that players can quickly access and download necessary game data. In multiplayer games, the server 110 can manage matchmaking, pairing players based on their skill levels, preferences, and other criteria. Once matched, the server 110 may establish and manage game sessions, ensuring that players are connected to the appropriate game instances and maintaining the integrity of these sessions.

The server 110 may also be configured to store and manages all necessary game data, including user profiles, game progress, leaderboards, and in-game statistics. This data can be stored in secure databases and accessed and updated as needed to reflect players' actions and achievements within the game. To maintain a fair gaming environment, various embodiments of the server 110 can implement security measures and anti-cheat systems. These measures can be configured to detect and prevent unauthorized modifications, hacks, or exploits that could disrupt the game's balance or give certain players unfair advantages.

Servers 110 can also collect and analyze data related to game performance, user behavior, and system health. This information may be used to monitor the game's performance, identify and address issues, and inform future updates and improvements. Analytics can also help in understanding player engagement and preferences, guiding the development of new features and content. In yet additional embodiments, the server 110 can facilitate social features, such as friend lists, messaging, and in-game communities. It can sometimes manage interactions between players, supports communication channels, and ensures that social features are integrated seamlessly into the gaming experience. To handle varying numbers of concurrent players, the server 110 can be designed to have a scalable infrastructure. This may include utilizing load balancing techniques to distribute the workload evenly across multiple servers, ensuring consistent performance and preventing any single server from becoming a bottleneck.

In many embodiments, the ecosystem 100 may utilize the internet 120 and wireless network devices like routers 150 to efficiently deliver data across various devices, ensuring seamless connectivity and gameplay. For wireless devices, such as mobile gaming consoles 140, tablets 180, and wearable devices 190, the router 150 can provide Wi-Fi connectivity. Modern routers support high-speed wireless standards like Wi-Fi 6, which offer faster data rates, lower latency, and improved handling of multiple devices simultaneously. This can ensure a stable and efficient connection for gaming, even in households with numerous connected devices.

As the game operates, data packets are transmitted between the player's device and the servers 110. These packets may include user inputs, game state updates, and synchronization data. The router 150 can handle the routing of these packets, directing them to their destination through the internet. Advanced Quality of Service (QoS) settings on routers can prioritize gaming traffic to ensure minimal latency and reduced lag, enhancing the gaming experience. During multiplayer sessions, the router 150 can play a role in maintaining a stable connection. It manages data traffic between multiple players, ensuring that game state updates and player interactions are synchronized in real-time. The ecosystem 100 can also be configured to utilize peer-to-peer (P2P) networking in conjunction with traditional client-server models. In P2P setups, game data may be shared directly between players' devices, reducing the load on central servers and improving data transfer speeds. The router 150 can, in certain embodiments, facilitate these direct connections, ensuring that data packets are correctly routed between peers.

In a number of embodiments, a PC 130 can download the game/game client from a digital storefront from one or more servers 110. Once installed, the game client can connect to the game's servers 110 via the internet 120, authenticating the user and syncing their game data. In certain embodiments, the PC 130 can also interact with other devices in the ecosystem 100. For example, a player might use a mobile app on their tablet 180 or smartphone 160 to manage their game inventory or chat with friends while playing on their PC 130. These interactions can be facilitated by one or more servers 110, which can synchronize data across all connected devices, ensuring a unified and cohesive gaming experience.

As those skilled in the art will recognize, home gaming consoles 145 are often specifically designed for gaming, providing a consistent and optimized experience without the need for extensive configuration. In various embodiments, home gaming consoles 145 frequently include social and community features that are tightly integrated into the ecosystem 100. Players can easily add friends, join parties, and communicate through voice or text chat. Additionally, game content distribution on home gaming consoles 145 often involves digital storefronts. In additional embodiments, consoles are designed to work seamlessly with various peripherals and accessories, such as controllers, headsets, and virtual reality (VR) devices.

In further embodiments, a mobile gaming console 140 has a design emphasizing portability, featuring a compact form factor, built-in display, and rechargeable battery. This allows players to continue their gaming sessions seamlessly when moving between different locations. In various embodiments, the game client and associated game logic on the mobile gaming console is optimized to handle the specific hardware and connectivity characteristics of these devices, ensuring smooth performance and efficient battery usage.

The mobile gaming console 140 can also connect to other devices through companion apps or cloud gaming services. For example, a player might use a mobile app on their console 140 to manage in-game items or communicate with friends, synchronizing this data with their main game profile on the servers 110. In certain embodiments, cloud gaming services can allow the mobile gaming console 140 to stream games from powerful servers 110, bypassing the need for high-end local hardware and ensuring access to graphically intensive games that would otherwise be beyond the device's capabilities.

Furthermore, mobile gaming consoles 140 can often support local multiplayer gaming through ad-hoc networks or Bluetooth connections. This may allow players to connect directly with other nearby mobile gaming consoles 140 for shared gaming experiences without relying solely on the internet. The servers 110 can then sync any local multiplayer progress with the broader ecosystem 100 once the devices reconnect to the internet 120.

Unlike stationary PCs 130, laptops 170, can be used in various environments, from home to public spaces. Many gaming laptops 170 come with dedicated GPUs, allowing for high-quality graphics and smooth gameplay. Laptops 170 may also support various peripheral connections, including external displays, gaming controllers, and VR headsets, expanding their gaming capabilities.

In more embodiments, smartphones 160 can offer unique features like GPS, accelerometers, gyroscopes, and cameras, which can be integrated into gameplay to provide augmented reality (AR) experiences and location-based gaming. Touchscreens are often standard on smartphones 160, facilitating intuitive controls and gestures. The ubiquity of smartphones 160 can ensure that players can engage with the game ecosystem wherever they are, and mobile-specific features like notifications keep players connected to in-game events and updates. Additionally, smartphones 160 may often include biometric security features such as fingerprint scanners and facial recognition, enhancing secure access to game accounts and in-game purchases.

In numerous embodiments, wearable devices 190, such as, but not limited to, smartwatches and AR glasses, can add a layer of interaction that extends beyond traditional gaming platforms. These devices can provide real-time notifications, health tracking, and context-sensitive interactions based on the player's environment. For example, a smartwatch might track physical activity during a fitness game, providing feedback and integrating physical activity into the gaming experience. In another example, AR glasses can overlay game elements onto the real world, creating immersive and interactive experiences that blend reality with the virtual game environment. Wearable devices 190 may also enable continuous engagement with the ecosystem 100 through haptic feedback and voice commands, allowing players to interact without needing to look at a screen.

In still more embodiments, tablets 180 can offer a larger screen size than smartphones while maintaining portability, making them ideal for immersive gameplay on the go. Tablets 180 may be configured to support both touch and stylus input, providing precise control options for games that require fine-tuned interactions. They may also be excellent for split-screen or multi-window functionality, enabling players to run multiple apps simultaneously, such as a game and a companion app. Tablets 180 can easily connect to external peripherals like keyboards and game controllers, bridging the gap between mobile and traditional gaming setups.

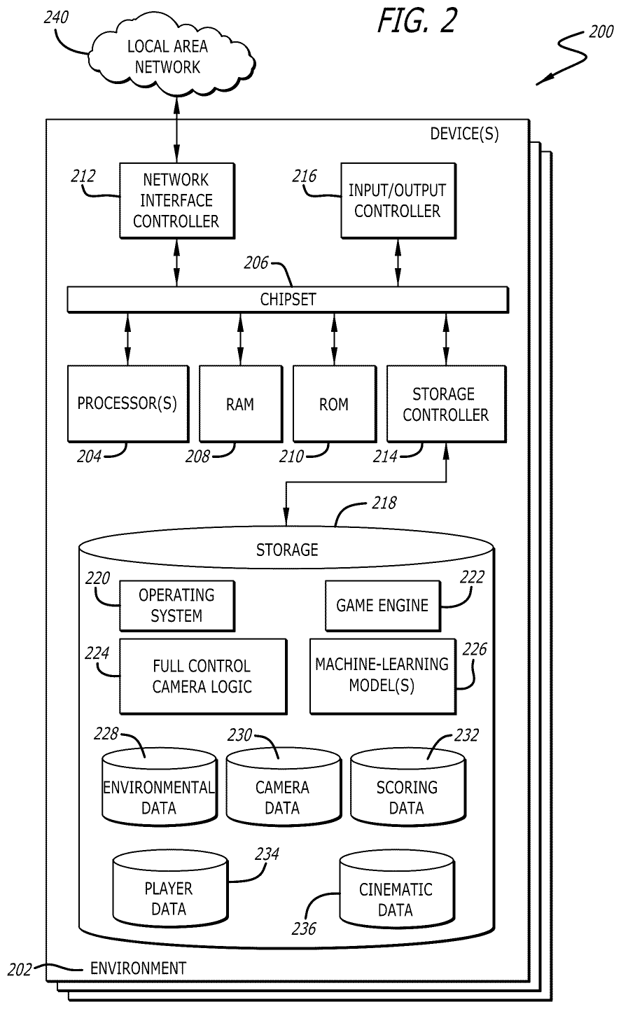

Although a specific embodiment for a video game ecosystem 100 is described above with respect to FIG. 1, any of a variety of systems and/or processes may be utilized in accordance with embodiments of the disclosure. For example, the video game ecosystem 100 may be configured into any number of various network topologies including different types of interconnected devices and user devices. The elements depicted in FIG. 1 may also be interchangeable with other elements of FIGS. 2-9 as required to realize a particularly desired embodiment.

Referring to FIG. 2, a conceptual block diagram of a device 200 suitable for configuration with a full control camera logic 224, in accordance with various embodiments of the disclosure is shown. The embodiment of the conceptual block diagram depicted in FIG. 2 can illustrate a conventional game device, personal computer, mobile game device, game server, laptop, tablet, network appliance, e-reader, smartphone, wearable device, or other computing device, and can be utilized to execute any of the application and/or logic components presented herein. The device 200 may, in many non-limiting examples, correspond to physical devices or to virtual resources described herein.

In many embodiments, the device 200 may include an environment 202 such as a baseboard or “motherboard,” in physical embodiments that can be configured as a printed circuit board with a multitude of components or devices connected by way of a system bus or other electrical communication paths. Conceptually, in virtualized embodiments, the environment 202 may be a virtual environment that encompasses and executes the remaining components and resources of the device 200. In more embodiments, one or more processors 204, such as, but not limited to, central processing units (“CPUs”) can be configured to operate in conjunction with a chipset 206. The processor(s) 204 can be standard programmable CPUs that perform arithmetic and logical operations necessary for the operation of the device 200.

In a number of embodiments, the processor(s) 204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 206 may provide an interface between the processor(s) 204 and the remainder of the components and devices within the environment 202. The device 200 can incorporate different types of processors to enhance performance and efficiency across various tasks. A central processing unit (CPU) can handle primary processing tasks such as game logic, AI, and player inputs, while a graphics processing unit (GPU) can be specialized for rendering high-resolution graphics and visual effects. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations, further enhancing the realism and responsiveness of the gaming experience. However, those skilled in the art will recognize that the device 200 can any variety or combination of processor(s) 204 as needed to satisfy the desired application.

The chipset 206 can provide an interface to a random-access memory (“RAM”) 208, which can be used as the main memory in the device 200 in some embodiments. The chipset 206 can further be configured to provide an interface to a computer-readable storage medium such as a read-only memory (“ROM”) 210 or non-volatile RAM (“NVRAM”) for storing basic routines that can help with various tasks such as, but not limited to, starting up the device 200 and/or transferring information between the various components and devices. The ROM 210 or NVRAM can also store other application components necessary for the operation of the device 200 in accordance with various embodiments described herein.

Additional embodiments of the device 200 can be configured to operate in a networked environment using logical connections to remote computing devices and computer systems through a network, such as the local area network 240. The chipset 206 can include functionality for providing network connectivity through a network interface controller (“NIC”) 212, which may comprise a gigabit Ethernet adapter or similar component. The NIC 212 can be capable of connecting the device 200 to other devices over the local area network 240. It is contemplated that multiple NICs 212 may be present in the device 200, connecting the device to other types of networks and remote systems, such as the Internet.

In further embodiments, the device 200 can be connected to a storage 218 that provides non-volatile storage for data accessible by the device 200. The storage 218 can, for instance, store an operating system 220, and/or game engine 222. In various embodiments, the storage 218 can be connected to the environment 202 through a storage controller 214 connected to the chipset 206. In certain embodiments, the storage 218 can consist of one or more physical storage units. The storage controller 214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 200 can store data within the storage 218 by transforming the physical state of the physical storage units to reflect the information being stored. The specific transformation of physical state can depend on various factors. Examples of such factors can include, but are not limited to, the technology used to implement the physical storage units, whether the storage 218 is characterized as primary or secondary storage, and the like.

In many more embodiments, the device 200 can store information within the storage 218 by issuing instructions through the storage controller 214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. In some embodiments, the device 200 can further read or access information from the storage 218 by detecting the physical states or characteristics of one or more particular locations within the physical storage units.

In addition to the storage 218 described above, certain embodiments of the device 200 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 200. In some examples, operations performed by a cloud computing network, and or any components included therein, may be supported by one or more devices similar to device 200. Stated otherwise, some or all of the operations performed by the cloud computing network, and or any components included therein, may be performed by one or more devices 200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 218 can store an operating system 220 utilized to control the operation of the device 200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 218 can store other system or application programs and data utilized by the device 200.

In many additional embodiments, the storage 218 or other computer-readable storage media is encoded with computer-executable instructions which, when loaded into the device 200, may transform it from a general-purpose computing system into a special-purpose computer capable of implementing the embodiments described herein. These computer-executable instructions may be stored as application and transform the device 200 by specifying how the processor(s) 204 can transition between states, as described above. In some embodiments, the device 200 has access to computer-readable storage media storing computer-executable instructions which, when executed by the device 200, perform the various processes described above with regard to FIGS. 1 and 3-12. In certain embodiments, the device 200 can also include computer-readable storage media having instructions stored thereupon for performing any of the other computer-implemented operations described herein.

In a number of embodiments, the device 200 can store a game engine 222 in storage 218 and load it when the game is launched, enabling quick access and execution. The game engine 222 can manage core tasks such as rendering graphics, processing inputs, handling physics calculations, and managing audio by leveraging the device's CPU, GPU, and other hardware components. It can abstract hardware complexities to ensure smooth gameplay and real-time interaction. Additionally, in various embodiments, the game engine 222 cam facilitate network communications for multiplayer interactions and supports cross-platform functionality, allowing games to run efficiently on various devices within the available game ecosystem.

In many further embodiments, the device 200 may include a full control camera logic 224. The full control camera logic 224 can be configured to perform one or more of the various steps, processes, operations, and/or other methods that are described above. Often, the full control camera logic 224 can be a set of instructions stored within a non-volatile memory that, when executed by the processor(s)/controller(s) 204 can carry out these steps, etc. In some embodiments, the full control camera logic 224 may be a client application that resides on a network-connected device, such as, but not limited to, a server, switch, personal or mobile computing device in a single or distributed arrangement.

In some embodiments, environmental data 228 can comprise various sub-data types point of interest data, environmental dimension data, play area data, and/or camera location data. In various embodiments, point of interest data can be utilized to highlight key objects or characters that the camera should focus on, ensuring that important elements are always in view. Environmental dimension data may provide the spatial parameters of the game environment that is being evaluated and/or rendered, allowing the camera to navigate and position itself accurately within that three-dimensional space. Play area data can be configured to define the boundaries and active regions where the player can move and/or gameplay can occur, helping the camera maintain optimal angles. Camera location data may include information about the current and potential positions of the camera, enabling dynamic adjustments to provide the best perspectives and avoid obstacles.

In more embodiments, camera data 230 may be utilized by a fully controlled camera system to facilitate the automatic management of camera movements for enhancement of the player's experience without requiring manual input. In some embodiments, the camera data 230 may comprise lens data for capturing information about focal length, aperture, depth of field, and the like, suitable for simulating real-world camera effects. Movement data can track and capture the camera's position and motion through the game environment. Base score data can include a base line score that each camera starts from when calculating a score for virtual editing. Framing data can ensures that key elements and characters are appropriately centered and visible within the frame. Camera type data may be configured to define the specific camera model or style being simulated, such as a handheld, Steadicam, cinematic, camcorder, drone camera, etc. Cameraman data can simulate or describe any human-operated camera movements, noise, or attributes to simulate a human camera operator, adding a layer of realism by mimicking how a person would handle the camera. Finally, camera weight data can account for the physical characteristics of the camera, influencing its inertia and how it responds to movements, contributing to a more authentic visual experience.

In further embodiments, scoring data 232 can include various sub-types of data including, but not limited to framing score data, player preference data, and update data. Framing score data can include various weights and items that can be utilized when generating a score for an associated camera point within a game environment. In some embodiments, player preference data can include data associated with one or more known player preferences, which can be captured from previous or historical gameplay, or “hints” provided to the game system, such as controller interactions. Finally, update data may provide one or more modifications to the weights utilized in one or more cameras or camera points when generating a score. For example, a certain camera within a game environment may never be selected due to the initial configuration of weights. Update data may allow for the modification of those weights such that the camera becomes a viable option for automatic cutting.

In various embodiments, player data 234 can comprise player type data as player movement data, among others. Player type data can be configured to describe one or more attributes related to the player and their current avatar or move set. For example, a player may have either a short-range attack or a long-range attack, which can be captured within the player type data. Similarly, play movement data may allow for the capture of characteristics to how the player may be able to move within a given game environment (running, walking, jumping abilities, etc.).

In still more embodiments, cinematic data 236 can include various heuristic data and telemetry data. As described in more detail below, heuristic data can include one or more heuristics associated with various cinematography or photography practices. In some embodiments, the heuristic data can be manually fine-tuned for a specifically desired game experience. However, as games are released and played by various players, telemetry data may be generated that gathers and otherwise transmits data related to various playthroughs done by players. In this way, the telemetry data can be used to update the game as desired by the game designers. For example, the telemetry data may indicate that players largely miss finding a particular hidden item in a gaming environment because a certain camera point is never selected. Utilizing this telemetry data, updates to the weights of the cameras within that gaming environment can be deployed such that more players may find that hidden item in the game.

In still further embodiments, the device 200 can also include one or more input/output controllers 216 for receiving and processing input from a number of input devices, such as a keyboard, a mouse, a touchpad, a touch screen, an electronic stylus, or other type of input device. Similarly, an input/output controller 216 can be configured to provide output to a display, such as a computer monitor, a flat panel display, a digital projector, a printer, or other type of output device. Those skilled in the art will recognize that the device 200 might not include all of the components shown in FIG. 2 and can include other components that are not explicitly shown in FIG. 2 or might utilize an architecture completely different than that shown in FIG. 2.

As described above, the device 200 may support a virtualization layer, such as one or more virtual resources executing on the device 200. In some examples, the virtualization layer may be supported by a hypervisor that provides one or more virtual machines running on the device 200 to perform functions described herein. The virtualization layer may generally support a virtual resource that performs at least a portion of the techniques described herein.

Finally, in numerous additional embodiments, data may be processed into a format usable by one or more machine-learning models 226 (e.g., feature vectors), and or other pre-processing techniques. The machine-learning (“ML”) models 226 may be any type of ML model, such as supervised models, reinforcement models, and/or unsupervised models. The ML models 226 may include one or more of linear regression models, logistic regression models, decision trees, Naïve Bayes models, neural networks, k-means cluster models, random forest models, and/or other types of ML models 226.

The ML model(s) 226 can be configured to generate inferences to make predictions or draw conclusions from data. An inference can be considered the output of a process of applying a model to new data. This can occur by learning from at least the environmental data 228, the camera data 230, the scoring data 232, player data 234, and/or the cinematic data 236. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a set of coordinates within a three-dimensional space, a probability distribution, a set of labels/characteristics/parameters, a decision about an action to take, etc. Ground truth for the ML model(s) 226 may be generated by human/administrator verifications or may compare predicted outcomes with actual outcomes.

Although a specific embodiment for a device suitable for configuration with the full control camera logic suitable for carrying out the various steps, processes, methods, and operations described herein is discussed with respect to FIG. 2, any of a variety of systems and/or processes may be utilized in accordance with embodiments of the disclosure. For example, the device 200 may be in a virtual environment such as a cloud-based game administration environment, or it may be distributed across a variety of network devices or servers. The elements depicted in FIG. 2 may also be interchangeable with other elements of FIGS. 1 and 3-9 as required to realize a particularly desired embodiment.

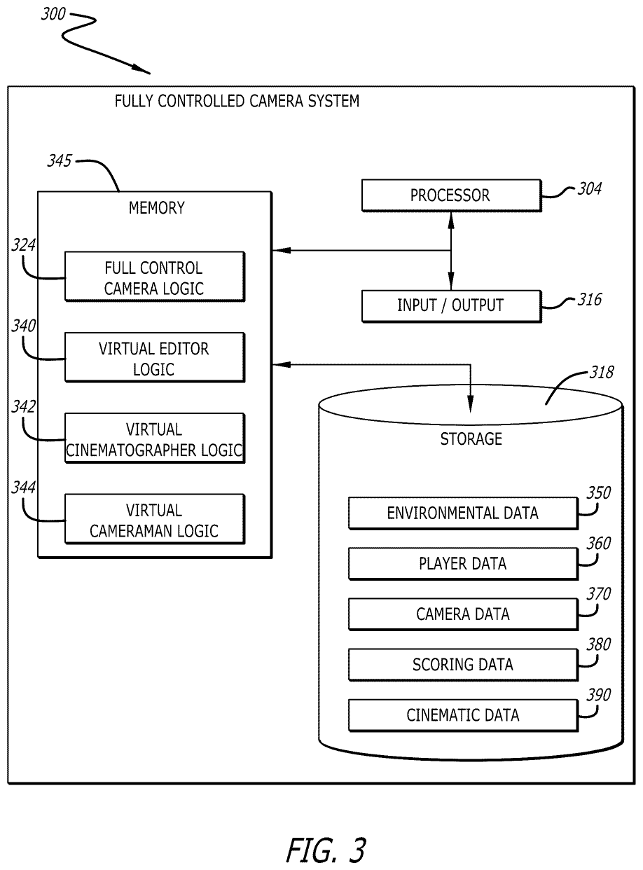

Referring to FIG. 3, an abstract block diagram of the components of a fully controlled camera system 300 in accordance with various embodiments of the disclosure is shown. In many embodiments, the fully controlled camera system 300 can be configured to include at least one or more processors 304, input/output functionality 316, a storage 318 as well as a memory 345 configured for executing one or more various logics. Specifically in the embodiment depicted in FIG. 3, the memory 345 comprises a full control camera logic 324 as well as a virtual editor logic 340, virtual cinematographer logic 342, and a virtual cameraman logic 344. Similarly, the storage 318 may comprise environmental data 350, player data 360, camera data 370, scoring data 380, and cinematic data 390.

In some embodiments, the full control camera logic 324 can facilitate the use of a camera system within a video game that is fully controlled by the system without input from the player. In certain embodiments, the full control camera logic 324 can work in conjunction with various other logics, such as a virtual editor logic 340, virtual cinematographer logic 342 and virtual cameraman logic 344. These logics may be configured as separate logics or may be interconnected or packaged/executed as a single logic.

In many embodiments, a virtual editor logic 340 in a fully controlled camera system 300 may consist of heuristics and rules designed to automatically adjust camera settings and movements to optimize the visual presentation of the game. This logic can analyze real-time game data and predefined criteria to make dynamic decisions about camera angles, transitions, and framing. Components of this analysis may include scene analysis, where the system evaluates the current context, such as the position of characters, action intensity, and environmental features, and the like. It could then use this analysis to choose the most appropriate camera angle and movement style, ensuring that important actions and details are highlighted effectively. In certain embodiments, this analysis may be done by evaluating different scores attached or otherwise associated with each available camera point within a gaming environment.

In a number of embodiments, a virtual cinematographer logic 342 may consist of heuristics and decision-making processes designed to simulate the artistic choices made by a human cinematographer. The virtual cinematographer logic 342 may, in various embodiments, analyze real-time game data and pre-defined cinematic rules to automatically control camera angles, movements, and transitions, enhancing the storytelling and gameplay experience. This logic may incorporate various data inputs, such as lens data, movement data, base score data, framing data, camera type data, cameraman data, and camera weight data, to create visually appealing and contextually appropriate scenes.

In more embodiments, the virtual cinematographer logic 342 can dynamically adjust the camera or selection of a pre-established camera point based on in-game events, character actions, and environmental cues. For example, it could switch to a close-up during a dramatic dialogue, pan to follow a fast-moving character, or adopt a wide-angle shot to showcase expansive landscapes or other points of interest. In further embodiments, the virtual cinematographer logic 342 may also account for cinematic techniques such as rule of thirds, leading lines, and depth of field to ensure aesthetically pleasing compositions. Additionally, this logic would manage transitions between different camera angles and movements smoothly, maintaining continuity and immersion.

In yet more embodiments, a virtual cameraman logic 344 may comprise a set of heuristics and rules designed to mimic the decisions, sounds, and movements of a human cameraman, creating a dynamic and immersive visual experience. This logic can process various types of camera data 370, such as lens settings, movement parameters, and framing preferences, to determine the best camera angles and transitions in real-time. In certain embodiments the virtual cameraman logic 344 may utilize the game's context, such as the player's actions, environmental changes, and narrative elements, to adjust the camera's position and orientation realistically.

The virtual cameraman logic 344 may also incorporate elements like camera type and cameraman data to simulate different styles of camera work, such as steady shots, handheld movements, or dramatic zooms and pans. Additionally, certain embodiments of the virtual cameraman logic 344 can evaluate can incorporate sounds and other action or indications that a real person is behind the game camera, increasing the overall level of realism within the game scene.

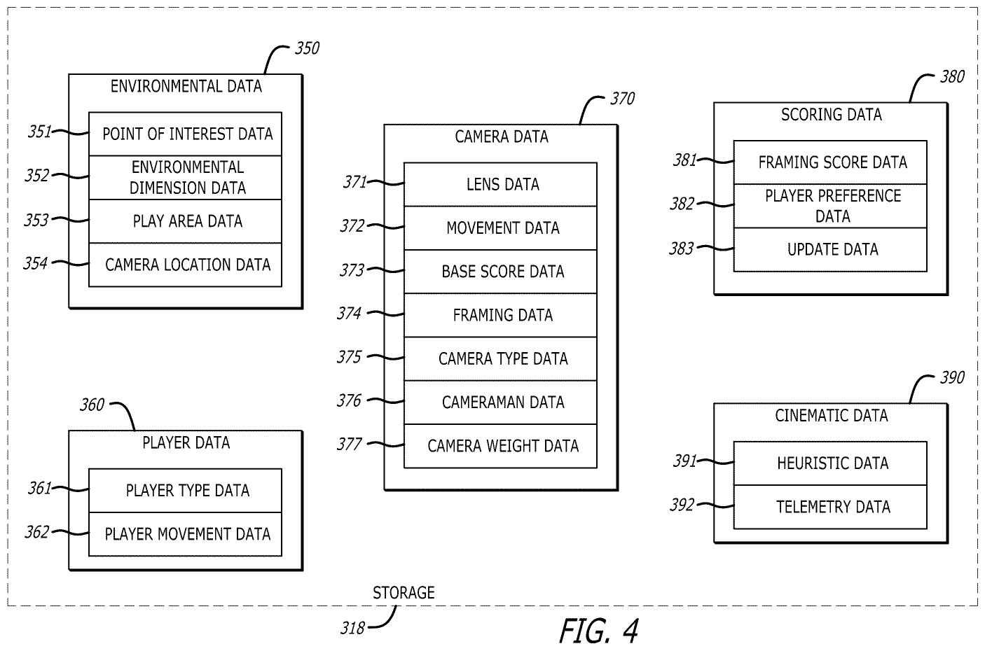

As discussed above in the embodiment depicted in FIG. 2, and in more detail below in the embodiment depicted in FIG. 4, the fully controlled camera system 300 may include a number of different types of available data to work with. These data may include environmental data 350 that can capture various aspects of the gaming environment being rendered and utilized. There may also be player data 360 that can describe different attributes of the player and their current avatar. Camera data 370 can be configured to provide various types of information related to how a camera may be set up, moved, and selected within a gaming environment. Scoring data 380 can help guide the system to determine what the correct or optimal score would be for each camera. Finally, cinematic data 390 can provide any specific heuristic or telemetry data that can better indicate what camera would be best be selected in a fully controlled camera system 300.

Although a specific embodiment for an abstract block diagram of the components of a fully controlled camera system 300 suitable for carrying out the various steps, processes, methods, and operations described herein is discussed with respect to FIG. 3, any of a variety of systems and/or processes may be utilized in accordance with embodiments of the disclosure. For example, the memory 345 can be an active memory that has the logics loaded/configured and is currently executing the various steps, processes, and/or methods described herein. In some embodiments, the memory 345 may be in a virtual environment such as a cloud-based game administration environment, or it may be distributed across a variety of network devices or servers. The elements depicted in FIG. 3 may also be interchangeable with other elements of FIGS. 1-2 and 4-9 as required to realize a particularly desired embodiment.

Referring to FIG. 4, an abstract block diagram of the data within a storage 318 of a fully controlled camera system in accordance with various embodiments of the disclosure is shown. In many embodiments, environmental data 350 may comprise various sub-types of data like point of interest data 351, environmental dimension data 352, play area data 353, and/or camera location data 354. However, as those skilled in the art will recognize, many other types of data may be included as well depending on the specific game and/or application.

In a number of embodiments, point of interest data 351 can include elements within the game environment that the camera should focus on or highlight. This data can encompass characters, significant objects, and interactive elements that are crucial to the gameplay or narrative. It may also include dynamic events, such as explosions, actions performed by the player or non-player characters, and environmental changes like weather effects. Additionally, point of interest data 351 may take into account contextual cues, such as dialogue or mission objectives, such that the camera may capture the most relevant and engaging aspects of the scene. This data can be formatted in a number of ways but may be a list of coordinates within a three-dimensional space and a corresponding value or score.

In more embodiments, environmental dimension data 352 can be configured as information about the game world's spatial and contextual characteristics. This data may include the size, shape, and layout of various game environments, such as rooms, outdoor areas, and obstacle placements, which helps the camera system navigate and frame scenes effectively. It can also comprise the dynamic elements within the environment, like moving objects, lighting conditions, and weather effects, to adjust camera settings and movements accordingly. Additionally, environmental dimension data 352 may account for interactive elements and potential player actions within these spaces, ensuring that the camera can anticipate and smoothly follow the player's movements while maintaining optimal angles and visibility of key gameplay moments.

In additional embodiments, play area data 353 can comprise various information for determining how a camera may be positioned and moved within the game's environment. This data may also include the spatial dimensions of the game environment where the player may traverse, including, but not limited to, boundaries, obstacles, and key landmarks, which can be utilized to help a camera navigate the environment without clipping through objects or getting obstructed. In certain embodiments, the play area data 353 may also incorporate dynamic elements like the location and movement patterns of characters, enemies, and interactive objects, ensuring they are effectively captured within the frame. Additionally, play area data might include designated points of interest or focal points that the camera should highlight during specific events or actions.

In further embodiments, camera location data 354 may include detailed information about the camera's spatial coordinates within the game environment, its orientation or rotation angles (pitch, yaw, and roll), and its movement vectors. This data can ensure that the camera can dynamically and accurately follow the action, providing optimal viewing angles and perspectives. In certain embodiments, the camera location data 354 may also encompass the camera's distance from the subject, height relative to the ground, and any constraints or boundaries to prevent clipping through objects or environments. Additionally, location data might include predefined waypoints or paths for scripted sequences, ensuring smooth transitions and cinematic shots.

In still more embodiments, player data 360 can include player type data 361 and player movement data 362. Player data 360 may be formatted as a list of attributes or parameters. In some embodiments, the player data 360 be a structure with a set of values that can be interpreted by other logic to implement one or more actions.

In yet further embodiments, player type data 361 may be configured as various attributes and preferences that define the player's or the player's avatar interaction style, skill level, and/or behavior patterns within the game. This data could encompass the player's preferred control settings, such as sensitivity levels for camera movement and specific input configurations. In some embodiments, the player type data 361 may also include information about the player's skill level, which can be inferred from gameplay statistics like reaction times, accuracy, and completion rates. Additionally, player type data 361 could track behavioral patterns, such as tendencies to explore, engage in combat, or focus on story-driven elements.

In still additional embodiments, player movement data 362 can comprise a comprehensive set of information detailing the player's actions and position within the game environment. In certain embodiments, this data may encompass the player's coordinates (X, Y, Z) in a three-dimensional virtual world for example, as well as direction and speed of the movement, and any changes in posture or stance (such as crouching, jumping, or lying prone). It may also include the player's interaction with the environment, such as climbing, swimming, or using objects. Additionally, player movement data 362 may capture or otherwise be modified to reflect input from controllers or keyboards, or other in-game actions.

In many embodiments, camera data 370 may include data related to the virtual camera rendering the game environment, such as, but not limited to, lens data 371, movement data 372, framing data 374, camera type data 375, cameraman data 376, and camera weight data 377. In various embodiments, other factors related to the camera, such as the base score data 373 can reflect a minimum score level for evaluation of a camera by a virtual editor logic.

In a number of embodiments, lens data 371 may comprise several elements that can define how the camera captures the visual scene. This may include the virtual focal length, which determines the field of view and how zoomed in or out the image appears. Aperture settings, which can control the depth of field and the amount of light entering the virtual lens, may also be part of lens data 371. Additionally, it can include information about focus distance, which affects how sharp or blurred objects appear at different distances. Lens data 371 might also capture lens distortion parameters to simulate the curvature or warping effects seen with certain types of lenses.

In more embodiments, movement data 372 can be configured as several components that may dictate how the camera transitions and orients itself in the game environment. This can include the camera's position coordinates (X, Y, Z) relative to the scene, ensuring it can move fluidly to follow the action or adjust perspective. It may also encompass the direction and velocity of the camera's movement, determining how quickly and smoothly it can pan, tilt, or zoom to new viewpoints. Additionally, rotational data can specify the camera's orientation in terms of pitch, yaw, and roll, allowing it to angle correctly and maintain a steady focus on important game elements. This data might also include interpolation methods to ensure smooth transitions between different camera positions and angles, as well as collision detection to prevent the virtual camera from passing through objects.

In additional embodiments, base score data 373 can relate to any initial settings or scores that are assigned to specific cameras. As discussed below, received telemetry data 392 and other update data 383 may require adjustment of the base score data 373 for specific virtual camera points within the game environment. In this way, certain issues can be addressed such as a camera failing to trigger in a fully controlled camera game, or a virtual camera being relied on for too long, which can remove some of the realism of that area of the game.

In further embodiments, framing data 374 may be comprised of several elements that can ensure the visual composition is aesthetically pleasing and functionally effective. In some embodiments, the framing data 374 can include the positioning of primary and secondary subjects within the frame, ensuring that key characters, objects, or actions are properly centered or placed according to various cinematic guidelines. Framing data 374 may also involve determining the appropriate zoom level and field of view to capture necessary details while maintaining contextual awareness of the surroundings. Framing data 374 can also be configured to consider the balance and symmetry of visual elements, managing empty space (negative space) around subjects to avoid cluttered or overly sparse scenes. Additionally, in certain embodiments, framing data 374 can take into account dynamic adjustments, such as re-framing during fast movements or significant scene changes, to keep important elements within the viewer's focus consistently.

In still more embodiments, camera type data 375 can comprise various attributes and settings that may define the specific characteristics and behaviors of the camera being simulated within the game. This can include the camera model, which dictates its physical properties such as size, shape, and weight. It may also encompass the type of lenses that may be used, such as wide-angle, telephoto, or fisheye, which affects the field of view and the degree of distortion. Additionally, in certain embodiments camera type data 375 can include preset configurations for different filming styles, such as stationary, handheld, drone, or Steadicam, each with unique movement and stabilization characteristics. This data may also specify the camera's response to environmental factors like lighting conditions and motion, as well as any built-in effects like zoom capabilities or focus adjustments.

In more further embodiments, cameraman data 376 may include, within the context of a virtual cameraman logic, may be comprised of parameters and attributes that simulate the behavior and decisions of a human camera operator. This data can include predefined movement patterns and styles, such as smooth tracking shots, dynamic panning, or quick zooms, based on the narrative or gameplay requirements. It may also encompass reaction times and sensitivity settings to mimic how a real cameraman would adjust to sudden changes in the scene, such as quick player movements or unexpected events. Additionally, cameraman data 376 can include preferences for framing, such as maintaining a certain distance from the player or focusing on specific elements within the environment as well as sound which can be reflected in additions to the game's sound generated during gameplay.

In still additional embodiments, camera weight data 377 can be associated with information that simulates the physical characteristics and inertia of the virtual camera, contributing to more realistic and dynamic camera movements. This data may include the simulated mass of the camera, which affects how it accelerates, decelerates, and responds to movements or changes in direction. It also encompasses the center of gravity and distribution of weight, which influence the balance and stability of the camera. Additionally, camera weight data 377 may account for the damping and friction parameters, which determine how smoothly the camera transitions between movements and how it handles sudden stops or starts.

In numerous embodiments, scoring data 380 can include various types of data that can affect the scoring of each camera within a gaming environment. This may include, for example, framing score data 381, player preference data 382, and update data 383. However, as those skilled in the art will recognize, other types of scoring data 380 may be utilized as needed.

In a number of embodiments, framing score data 381 may comprise an evaluation and ranking for different camera perspectives based on their effectiveness in framing key elements within the gaming environment. This data can be configured to assess the composition of each shot, ensuring that important subjects, such as the player character, NPCs, and significant objects, are properly positioned according to various cinematic principles like the rule of thirds, balance, focus, etc. An analysis of real-time game scenes can be done to assign scores to various camera angles or camera points based on their ability to highlight crucial action or narrative elements clearly and engagingly.

In more embodiments, player preference data 382 can relate to information tailored to individual player choices and habits, influencing how the camera system adjusts to enhance their gaming experience. This data can include preferred camera angles and perspectives, such as a first-person view, third-person over-the-shoulder view, or top-down perspective. These preferences can be communicated in the form of “hints” such as pushing one or more inputs, etc. The player preference data 382 can also take into account the player's adjustments to camera sensitivity and movement speed, reflecting their comfort level and play style. Additionally, player preference data 382 can capture preferred zoom levels, focus points during different gameplay scenarios (combat, exploration, cutscenes), and any specific settings related to camera behavior, such as automatic panning or manual control options.

In further embodiments, update data 383 can comprise information necessary to keep the camera system and overall game experience current and functioning optimally. This may include patches and bug fixes to address any issues or glitches that have been identified in the camera system or game mechanics. It may also encompass new features and enhancements that improve camera control, such as additional camera angles, improved AI for the virtual cameraman. Furthermore, update data may contain adjustments based on player feedback and telemetry data 392, such as refined camera movement to better match player preferences or optimized performance for different hardware configurations.

In additional embodiments, cinematic data 390 may comprise various data related to how virtual cameras can operate to comport with various photographic and cinematography principles, which can make the game experience seem more realistic and/or more cinematic. In some embodiments, the cinematic data 390 may include heuristic data 391 as well as telemetry data 392.

In still more embodiments, heuristic data 391 may include sets of commands, processes, and/or methods related to various principles that can aide in creating a more realistic and cinematic gaming experience. For example, heuristic data 391 may comprise various “if this, then that” transforms that can indicate when various actions should occur in response to other types of input or game states. In certain embodiments, heuristic data 391 may be formatted as an input into one or more machine learning processes for generation of an inference or output.

In yet further embodiments, telemetry data 392 can be associated with data that has been gathered from play tests or other playthroughs of the game by players. As players play the game, each playthrough may be unique depending on their choices as the player. Over time, this data can be captured in a private (i.e., non-identifying) manner and aggregated into telemetry data 392. This telemetry data 392 can subsequently be utilized to gather insight into the game experience, compare it to a model or desired experience, and generate decisions or update data 383 that can be useful in correcting or otherwise better guiding players through a more optimized game play experience.

Although a specific embodiment for an abstract block diagram of the data within a storage 318 of a fully controlled camera system suitable for carrying out the various steps, processes, methods, and operations described herein is discussed with respect to FIG. 4, any of a variety of systems and/or processes may be utilized in accordance with embodiments of the disclosure. For example, the data types described herein can vary depending on the type of application deployed and/or desired. For example, each specific data type may be concatenated into one data structure or be broken up into multiple additional data structures. Those skilled in the art will recognize that data can be formatted in a variety of ways beyond the specific embodiment depicted in FIG. 4. The elements depicted in FIG. 4 may also be interchangeable with other elements of FIGS. 1-3 and 5-9 as required to realize a particularly desired embodiment.

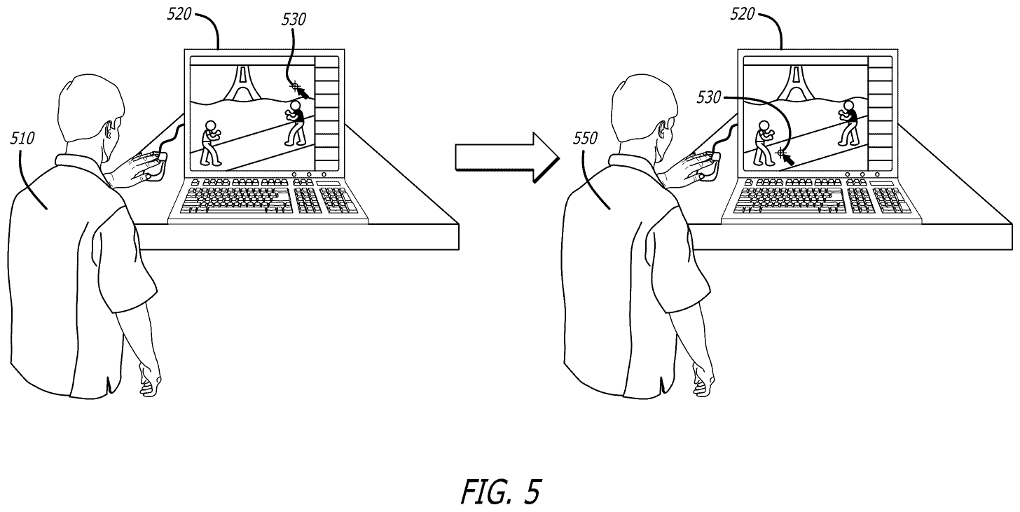

Referring to FIG. 5, a conceptual illustration of manual camera point setup in accordance with various embodiments of the disclosure is shown. In many embodiments, a game developer 510 at a first step in the editing process, can be setting up a plurality of camera points within a game environment 520. Using an editor to manually enter camera points in a game environment can involves a detailed and iterative process, allowing developers 510 to customize each camera point for optimal gameplay and visual storytelling. The first step typically involves opening the game's level editor, which provides a comprehensive view of the game environment(s), including the landscape, objects, characters, and existing camera points. The developer 510 can navigate through this environment 520 to identify strategic locations where new camera points could enhance the player's experience. These locations are often chosen based on key gameplay moments, narrative beats, or areas where players need better visibility or dramatic emphasis.

Once a suitable location is identified, the developer 510 can place a new camera point by clicking on the desired spot in the editor. In some embodiments, such as the embodiment depicted in FIG. 5, the developer 550 at the second step can manually move a camera point 530 from one area of the environment to another, until it is where the developer 550 desires it. In additional embodiments, a panel or window may be available to adjust or add various camera characteristics and parameters to the camera points. Parameters such as the camera's position and orientation can be adjusted to ensure the camera captures the intended view. The developer 550 can fine-tune other camera characteristics, such as the field of view (FOV) to control how much of the scene is visible, set the depth of field to determine the focus range, and choose the lens type to achieve specific visual effects. Additional settings that may be configured in the editor may include tracking behaviors, where the camera can follow a character or object, and transition parameters, which control how the camera switches between points smoothly.

In a number of embodiments, after configuring the basic parameters, the developer 550 may assign contextual behaviors to the camera point. For instance, it may be specified which trigger conditions activate the camera, such as when a player enters a certain area, completes a specific action, or reaches a particular narrative point. In some embodiments, these activation conditions can be used to supplant the fully controlled camera system. In numerous embodiments, the activation triggers may still be subservient to the fully controlled camera system and associated camera sores. These behaviors can ensure the camera changes enhance the gameplay flow and narrative coherence. The editor might also provide tools to simulate and preview these behaviors in real-time, allowing the developer to see how the camera point functions during actual gameplay scenarios.

Often, the process can be iterative, with the developer 550 continually testing and refining each camera point. In more embodiments, the developer 550 can enter playtest mode within the editor to experience the game from the player's perspective, triggering the new camera points and observing their performance. During this phase, the developer can check for issues such as awkward angles, visibility problems, or disorienting transitions. Any identified issues are addressed by returning to the editor and adjusting the camera's parameters until the desired effect is achieved.

Although a specific embodiment for a conceptual illustration of manual camera point setup suitable for carrying out the various steps, processes, methods, and operations described herein is discussed with respect to FIG. 5, any of a variety of systems and/or processes may be utilized in accordance with embodiments of the disclosure. For example, some embodiments may allow for adding and/or editing of the camera points within a game environment by accepting text-based or other raw files that can be parsed instead of receiving input directly from the game developers through an editor. The elements depicted in FIG. 5 may also be interchangeable with other elements of FIGS. 1-4 and 6-9 as required to realize a particularly desired embodiment.

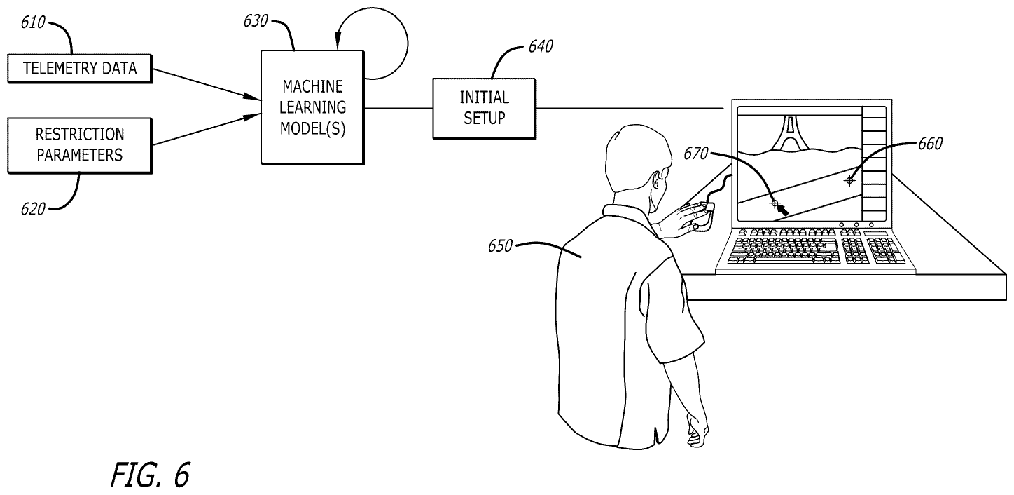

Referring to FIG. 6, a conceptual illustration of machine-learning assisted camera point setup in accordance with various embodiments of the disclosure is shown. As games grow in complexity and size, developers 650 may be tasked with entering and otherwise editing an increasingly large number of camera points within a fully controlled camera system. In some embodiments, instead of adding each camera point and associated characteristic manually, one or more automatic/machine learning/heuristic processes can be enlisted to at least provide an initial framework to work off of, even manually.

In the embodiment depicted in FIG. 6, a machine learning model 630 is utilized to accept telemetry data 610 and restriction parameters 620 as inputs. As described above, the actual data input format can vary based on the type of machine learning model 630 utilized. In certain embodiments, other types of input data may be utilized, or less data may be required. These input data can be utilized to generate output data that may then be fed back into the same or different machine learning model(s) 630. As a result of this processing, an initial setup 640 can be generated and delivered to the developer 650 for further processing such as manual editing. In the embodiment depicted in FIG. 6, the developer 650 the environment has a first camera point 660 and a second camera point 670 provided via the initial setup process.

Utilizing a machine learning model to process and add camera points initially, followed by manual editing, can be beneficial in several scenarios within a game environment. One primary scenario is in large, complex game worlds where the sheer number of potential camera points would make manual placement time-consuming and prone to human error. In open-world games or games with extensive, dynamic environments, a machine learning model can quickly generate a comprehensive set of initial camera points by analyzing the terrain, object positions, player paths, and potential points of interest.

Machine learning models can be trained on a telemetry-based dataset comprising various gameplay scenarios and player behaviors, learning to predict optimal camera placements that enhance visibility, maintain player orientation, and emphasize critical game moments. For example, in a stealth game, the model can identify areas where players are likely to engage in stealthy maneuvers and place cameras that provide clear views of both the player and their surroundings, ensuring that the player has the best possible vantage points for strategic planning.

Another beneficial scenario is in procedurally generated environments, where the game world changes each time it is played. Here, a machine learning model can dynamically place camera points in real-time based on the generated environment's layout and the player's movement patterns. This approach can ensure that even in unique or random game configurations, the camera system may remain effective and responsive, providing players with a consistently high-quality experience.

Although a specific embodiment for a conceptual illustration of machine-learning assisted camera point setup suitable for carrying out the various steps, processes, methods, and operations described herein is discussed with respect to FIG. 6, any of a variety of systems and/or processes may be utilized in accordance with embodiments of the disclosure. For example, in some embodiments, a heuristic-based process can be utilized in place of the machine learning model(s) 630. The elements depicted in FIG. 6 may also be interchangeable with other elements of FIGS. 1-5 and 7-9 as required to realize a particularly desired embodiment.

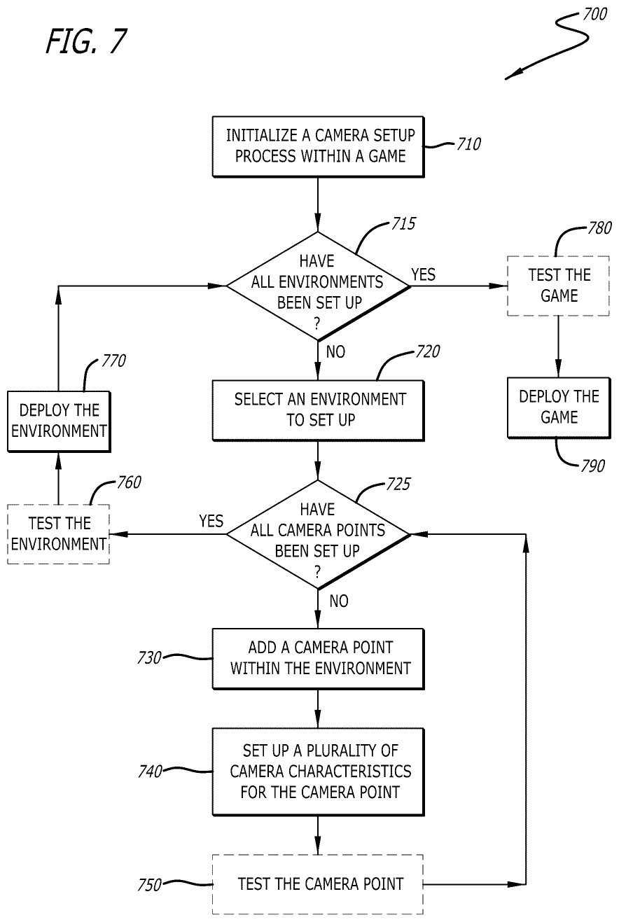

Referring to FIG. 7, a flowchart depicting a process 700 for setting up camera points in a game environment in accordance with various embodiments of the disclosure is shown. In many embodiments, the process 700 can initialize a camera setup process within a game (block 710). In some embodiments, this can involve using a dedicated editor tool that allows game developers to place and configure camera points within the game environment. A game developer may begin by opening the game's level editor, which can be configured to provide a visual representation of the game world. Within this editor, the developer can navigate through the environment and identify key areas where desired camera angles would enhance the gameplay experience. In certain embodiments, this editor tool can typically offer functionalities to add new camera points by clicking on desired locations and adjusting parameters such as position, orientation, field of view, movement behaviors, and other characteristics. Additionally, the editor may include a preview mode, allowing the developer to simulate and fine-tune the camera transitions in real-time, ensuring smooth and cinematic quality shots.

In a number of embodiments, the process 700 can determine if all available environments have been setup (block 715). As those skilled in the art will recognize, a game may have a number of different environments, scenes, or levels that demarcate various areas of the game. Each of these environments may be edited to add one or more camera points for a fully controlled camera system.

If the process 700 determines that all environments have not been set up, then various embodiments can select an environment to set up (block 720). A developer may select a particular environment to edit. In some embodiments, this process can be distributed and controlled with version control software such that only one developer or an otherwise authorized person is allowed to edit camera points at one time.

In more embodiments, the process 700 can determine if all camera points within the environment have been set up (block 725). Depending on the game and/or the environment, a particular number of type of camera points may be desired or even required. These types of guiderails or restrictions can be utilized to indicate to the developer(s) if more camera points should be added to the environment.

If it is determined that all of the camera points within the environment have not been set up, the process 700 can in numerous embodiments add a camera point within the environment (block 730). As discussed above, the placement of a camera point within a game environment can be done manually through one or more editors. In various embodiments, the editors can be a “what you see is what you get” editor.

In further embodiments, the process 700 can set up a plurality of camera characteristics for the camera point (block 740). The type of characteristics for the camera can be associated with the type of camera being added (e.g., drone style camera, cinematic camera, handheld camera, etc.). These characteristics can include the camera model, which dictates its physical properties such as size, shape, and weight. It may also encompass the type of lenses that may be used, such as wide-angle, telephoto, or fisheye, which affects the field of view and the degree of distortion. Additionally, in certain embodiments camera characteristics that can be edited may include preset configurations for different types of cameras.

In certain optional embodiments, the process 700 can test the camera point (block 750). In certain embodiments, testing can allow the developer to experience the game as a player would, navigating through the environment and triggering the newly added camera point. The developer can observe how the camera transitions to this new point, ensuring it activates at the appropriate time and provides the desired perspective. In some embodiments, the current camera score can be displayed to indicate how it is being calculated during fully controlled camera gameplay. If any issues are identified, such as awkward angles, poor visibility, or disorienting transitions, the developer can make real-time adjustments in the editor, iterating on the placement and settings of the camera point until it achieves the satisfactory performance.

If it is determined that all camera points have been set up, some optional embodiments may test the overall environment (block 760). Similar to testing the camera points, the developer can play the game throughout the entire environment and not just the specific area with the camera point under review. In this way, the handoff and score generation between the different cameras can be seen and any cuts or actions done that are not conducive to seamless gameplay can be edited until satisfactory performance is achieved.

In additional embodiments, the process 700 can deploy the environment (block 770). Once the game environment, including all tested camera points, has been thoroughly refined and validated, additional steps can be taken to ensure it is ready for players. First, the final version of the game environment can be integrated into the main build of the game, with all assets, scripts, and configurations included. A subsequent quality assurance (QA) testing phase may occur to catch any remaining issues and ensure compatibility across different hardware and platforms.

If it is determined that all environments have been set up, then various embodiments of the process 700 can optionally test the game (block 780). Again, the entire game can be compiled as a main build and sent to QA for testing prior to deployment. This process can help locate any remaining bugs or unusual behaviors that detract from a player's overall experience with the game.

In still more embodiments, the process 700 can deploy the game (block 790). After QA approval, the game build can be compiled and packaged into a deployable format. This package may then be uploaded to distribution platforms, such as digital storefronts or game consoles'online services. Finally, developers may perform a soft launch or beta testing with a small group of players to monitor real-world performance and gather additional feedback. Once everything is confirmed to be stable and performing as expected, the game environment can be officially released to the public, where players can experience the fully developed and optimized gameplay utilizing the fully controlled camera system.

Although a specific embodiment for a flowchart depicting a process 700 for setting up camera points in a game environment suitable for carrying out the various steps, processes, methods, and operations described herein is discussed with respect to FIG. 7, any of a variety of systems and/or processes may be utilized in accordance with embodiments of the disclosure. For example, some set up environments may allow for pragmatically adding camera points to the game, such as relative cameras that are placed in relation to a player or other game asset. The elements depicted in FIG. 7 may also be interchangeable with other elements of FIGS. 1-6 and 8-9 as required to realize a particularly desired embodiment.

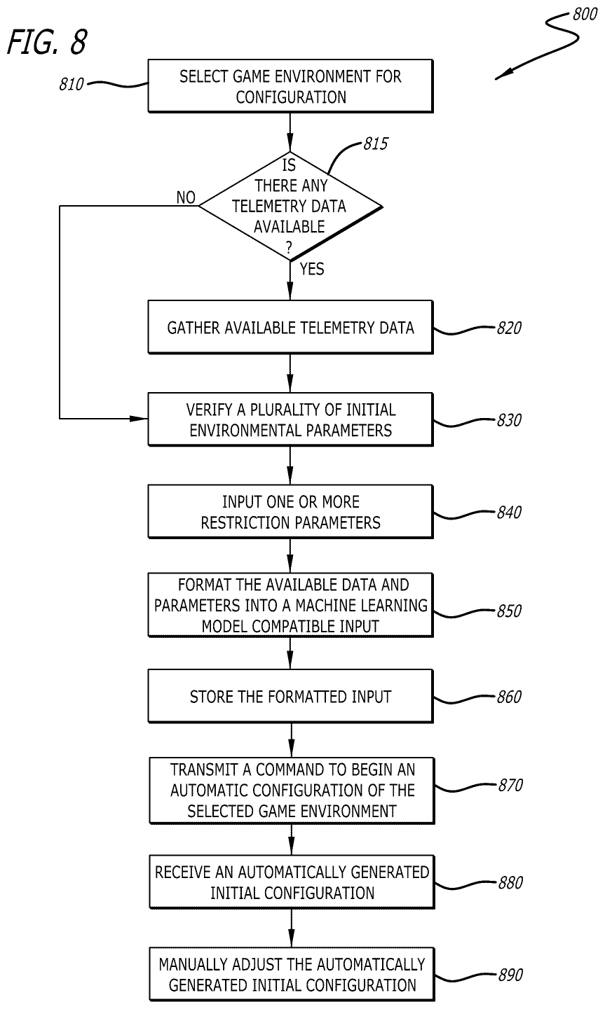

Referring to FIG. 8, a flowchart depicting a process 800 for a machine-learning assisted camera point setup in accordance with various embodiments of the disclosure is shown. Although some embodiments may provide for a way to manually add every camera point within a game, additional embodiments can provide at least a semi-automatic method for generating camera points that can subsequently be manually adjusted. In many embodiments, the process 800 can select a game environment for configuration (block 810). A developer may select a particular environment to edit. Each game may have a plurality of different environments to set up.

In a number of embodiments, the process 800 can determine if there is any telemetry data available (block 815). The telemetry data can be generated from previous past playthroughs, not only of the game, but also previously deployed games. In these embodiments, games of similar genres or that use similar environments can be utilized to generate telemetry data for use on subsequent games.

If it is determined that telemetry data is available, then various embodiments of the process 800 can gather the available telemetry data (block 820). Gathering the telemetry data can include accessing the data from some data storage or repository. This telemetry data can be sold and/or licensed by a third party as part of a software suite or kept internally from a previously developed game.

However, if there is no telemetry data available, then certain embodiments of the process 800 can verify a plurality of initial environmental parameters (block 830). In some embodiments, the environment can have various assets and items within it that can limit or change the environment. For example, a building or wall may prevent movement of a player character within an area. These parameters can limit where a camera point may be placed.

In more embodiments, the process 800 can input one or more restriction parameters (block 840). Similar to environmental parameters, restriction parameters can limit where and what kind of camera points can be placed. While environmental parameters are based on assets within an environment, restriction parameters are those set by the game developers, typically as a result of artistic choices. For example, a developer may require that all over-the-shoulder camera points be configured as handheld-style cameras, or that all overhead shots be configured as drone-style cameras, etc.

In further embodiments, the process 800 can format the available data and parameters into a machine learning model compatible input (block 850). As those skilled in the art will recognize, utilizing different automated methods to generate data may require an input data set that is properly formatted for processing. As such, the available data and parameters can be formatted in a compatible way for use in one of a plurality of different machine learning processes, or even a heuristic-based system.

In additional embodiments, the process 800 can store the formatted input (block 860). The formatted input can be stored in a general data storage device, or can be sent to a remote or cloud-based storage system. In certain embodiments, once formatted, the data may be put to use somewhat immediately, requiring only the storage of the formatted data in an intermediate or volatile memory for processing.

In still more embodiments, the process 800 can transmit a command to begin an automatic configuration of the selected game environment (block 870). The command may be transmitted as a result of a developer initiating the process. However, in some embodiments, the command may be issued as a result of the input data being processed correctly. The transmission of the command may be through one or more commands, function calls, or other user interface interactions.

In yet further embodiments, the process 800 can receive an automatically generated initial configuration (block 880). After processing, the output of that automatic camera point generation can be received. The initial configuration can be a file that can be applied to a game editor, or may be an environment ready to edit.

In some embodiments, the received automatically generated initial configuration may be the result of a multistage machine learning process. For example, a first machine learning model or a first plurality of machine learning models may be utilized to process available input data to determine optimal or suggested locations for one or more camera points within the selected interactive environment. Subsequently, a second machine learning model or a second plurality of machine learning models can process the output from the first models to determine and assign one or more camera characteristics to each of the suggested camera points, resulting in a more comprehensive and context aware initial configuration.

In more additional embodiments, the process 800 can manually adjust the automatically generated initial configuration (block 890). Upon receiving the automatically generated initial configuration, one or more manual edits may be desired, which can be done by a developer or with some additional heuristic-based process. In this way, game developers may be able to save time in setting up various camera point and camara parameter/characteristic settings, especially in larger games that can have multiple and/or large environments to set up.

Although a specific embodiment for a flowchart depicting a process 800 for a machine-learning assisted camera point setup suitable for carrying out the various steps, processes, methods, and operations described herein is discussed with respect to FIG. 8, any of a variety of systems and/or processes may be utilized in accordance with embodiments of the disclosure. For example, the automatic generation of camera points and/or parameters can be done within an editor itself, without the need to format and transmit the data. In these embodiments, the editor may itself provide an option to automatically generate an initial configuration. In fact, certain embodiments may be configured to, as a default setting, add a plurality of initial camera points and settings based on available data, such as historical data associated with the game developer. The elements depicted in FIG. 8 may also be interchangeable with other elements of FIGS. 1-7 and 9 as required to realize a particularly desired embodiment.

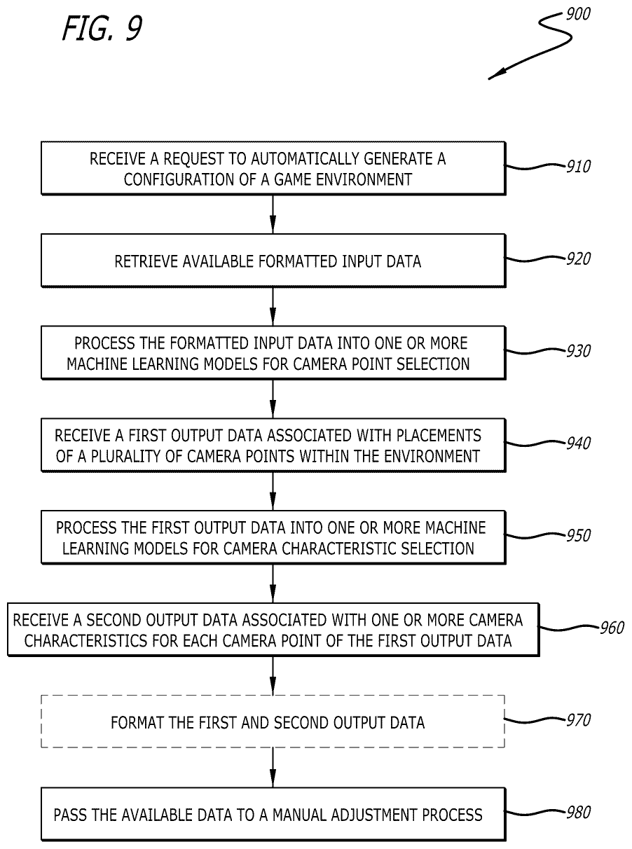

Referring to FIG. 9, a flowchart depicting a process 900 for automatically generating camera point suggestions in accordance with various embodiments of the disclosure is shown. While some game or environmental editors may have the ability to automatically generate a plurality of camera point locations and associated parameters, other editors may lack such tools and require external help. Embodiments described herein can receive data and generate those initial configurations for editors or other requesting entities.

In many embodiments, the process 900 can receive a request to automatically generate a configuration of a game environment (block 910). The request may be received as part of a function call, or through one or more interactions with a user interface, etc. In some embodiments, the request may be accompanied by the game environment that is to be configured.

It is contemplated that the received request can be part of a larger initialization of a camera setup process. For instance, a developer may launch a game editor and select an option to begin configuring the camera system for a plurality of interactive environments within a game. This action can trigger the request to automatically generate a configuration for a selected environment. The initialization process may also involve loading necessary assets, libraries, and default parameters that provide the context for the subsequent automatic generation and manual adjustment of camera points and their associated characteristics.

In a number of embodiments, the process 900 can retrieve available formatted input data (block 920). The formatted input data can be stored within a storage device that can be accessed upon receiving a proper memory address. In some embodiments, the formatted input data is provided as part of the initial request for configuration.

In more embodiments, the process 900 can process the formatted input data into one or more machine learning models for camera point selection (block 930). As those skilled in the art will recognize, a machine learning model can process the input data and generate one of a variety of outputs that can be configured to correspond to locations where one or more camera points and other camera parameters can be placed. However, in some embodiments, the process 900 can utilize a heuristic-based system that can process the formatted input data to generate similar output data.

In further embodiments, the process 900 can receive a first output data associated with placements of a plurality of camera points within the environment (block 940). In the embodiment depicted in the process 900 of FIG. 9, there are two separate steps or machine learning processes utilized. In the first step, the machine learning process can generate a list of potential camera points within the associated environment. This may be a list of coordinates within a three-dimensional space or other type of data format.

In additional embodiments, the process 900 can process the first output data into one or more machine learning models for camera characteristic selection (block 950). Similar to the other data formatted processes, the machine learning model or other heuristic-based process configured to generate camera characteristics may require data formatted into a particular structure to allow for processing. However, in some embodiments, the first step can be configured to automatically output data in a format compatible with the second step, thus negating the need for an additional formatting step.

In still more embodiments, the process 900 can receive a second output data associated with one or more camera characteristics for each camera point of the first output data (block 960). As discussed above, camera characteristics or parameters can be related to any aspect of a camera point beyond the location. The selection of additional camera characteristics can be done based on previous telemetry data or may be done in a more heuristic method that can be formatted to avoid breaking one or more cinematographic principles.

In certain optional embodiments, the process 900 can format the first and second output data (block 970). Again, depending on the method utilized, the second output data may also need to be formatted prior to subsequent processing. However, some embodiments may configure the process that generates the second output data to generate that second output data into a preconfigured format, negating this step.

In yet further embodiments, the process 900 can pass the available data to a manual adjustment process (block 980). In most embodiments, it will be the case that the camera points selected as well as the associated characteristics will be deployable upon initial generation. Instead, the automatically generated initial configuration can be a starting point for game developers to edit and create from. In this way, the developers may not have to manually add each new camera point and load every single potential camera characteristic/parameter. In addition, the game developers may be challenged with new combinations of camera location and type that serendipitous outcomes and gameplay may be possible.

Although a specific embodiment for a flowchart depicting a process 900 for automatically generating camera point suggestions suitable for carrying out the various steps, processes, methods, and operations described herein is discussed with respect to FIG. 9, any of a variety of systems and/or processes may be utilized in accordance with embodiments of the disclosure. For example, various embodiments may not require multiple steps of processing to get the initial configuration. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more. ” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a full control camera logic, stored in the memory and executed by the processor, configured to:
initialize a camera setup process within a plurality of interactive environments;
select one of the plurality of interactive environments;
set up at least one camera points within the selected one interactive environment;
add one or more camera characteristics to the at least one camera point;
determine if all of the plurality of interactive environments have been selected; and
deploy, upon determining that all of the plurality of interactive environments were selected, an interactive experience.

2. The device of claim 1, wherein the interactive experience is a video game environment.

3. The device of claim 2, wherein the interactive environments are unique portions of the video game environment.

4. The device of claim 3, wherein deploying the video game environment includes at least rendering a portion of at least one interactive environment.

5. The device of claim 4, wherein the rendering occurs in real-time or near real-time.

6. The device of claim 1, wherein the selected one of the plurality of interactive environments has telemetry data associated with it.

7. The device of claim 6, wherein the full control camera logic is further configured to receive one or more restriction parameters.

8. The device of claim 7, wherein the full control camera logic is further configured to format the camera characteristics and restriction parameters into a machine-learning compatible input.

9. The device of claim 8, wherein the full control camera logic is further configured to transmit machine-learning compatible input.

10. The device of claim 9, wherein the full control camera logic is further configured to receive an automatically generated initial configuration.

11. The device of claim 10, wherein the full control camera logic is further configured to receive one or more manual adjustments to the automatically generated initial configuration.

12. A device, comprising:
a processor;
a memory communicatively coupled to the processor; and
a full control camera logic, stored in the memory and executed by the processor, configured to:
select one of the plurality of interactive environments;
retrieve available input data;
process the input data through a first plurality of machine learning models;
receive a first output data associated with locations of one or more camera points within the selected interactive environment;
process the first output data through a second plurality of machine learning models; and
receive a second output data associated with one or more camera characteristics of the one or more camera points of the first output data.

13. The device of claim 12, wherein the interactive experience is a video game environment.

14. The device of claim 13, wherein the interactive environments are unique portions of the video game environment.

15. The device of claim 14, wherein deploying the video game environment includes at least rendering a portion of at least one interactive environment.

16. The device of claim 15, wherein the rendering occurs in real-time or near real-time.

17. The device of claim 1, wherein the wherein the available input data comprises at least telemetry data.

18. The device of claim 6, wherein the available input data comprises at least one or more restriction parameters.

19. A method of automatically generating camera configurations within interactive environments, comprising:
initializing a camera setup process within a plurality of the interactive environments;
selecting one of the plurality of the interactive environments;
setting up at least one camera points within the selected interactive environment;
adding one or more camera characteristics to the at least one camera point;
determining if all of the plurality of interactive environments have been selected; and
generating automatically, upon determining that all of the plurality of interactive environments were selected, an initial configuration.

20. The device of claim 19, wherein the method further comprises receiving one or more manual adjustments to the automatically generated initial configuration.
